(19) United States
(12) Patent Application Publication
(10) Pub. No.: US 2003/0191566 A1
(43) Pub. Date: Oct. 9, 2003

(54) System and method for detecting and reporting irregularities in fuel efficiency data

(75) Inventor: Uri Ben-Assa, Almere (NL)

Correspondence Address: DR. MARK FRIEDMAN LTD., C/o Bill Polkinghorn, Discovery Dispatch, 9003 Florin Way, Upper Marlboro, MD, 20772, US

(73) Assignee: ORPAK INDUSTRIES (1983) LTD.

(21) Appl. No.: 10/117,996

(22) Filed: Apr. 9, 2002

(51) Int. Cl. G06F 19/00

(52) U.S. Cl. 701/29; 340/438

(57) ABSTRACT

A system for detecting and reporting irregularities in fuel efficiency data vehicles. The system includes a database and a data processing mechanism. The data base includes fueling event data, vehicle identification data and data pertaining to an operational parameter. The data processing mechanism calculates a vehicle specific fuel efficiency statistic, compares the calculated statistic to a previous statistic employing a predetermined rule to determine if the newly calculated statistic is unreliable and prepares a report which indicates unreliable fuel efficiency statistics by vehicle. Further disclosed is a method for generating reports which indicate unreliable fuel efficiency statistics by vehicle.

### FIELD AND BACKGROUND OF THE INVENTION

The present invention relates to a system and method for detecting and reporting irregularities in fuel efficiency data of a vehicle and, more particularly, to a system and method for assuring that unauthorized removal of fuel from, or introduction of fuel into, a vehicle will be discovered.

In many cases it is desirable to audit the amount of fuel consumed by a vehicle in relation to a vehicle operation parameter (e.g. distance traveled, engine revolutions, duration of motor operation, etc.). In commercial fleets of vehicles, employees may be given a vehicle to use only for business related travel. Private travel may be either forbidden or subject to a fee. Further, transfer of fuel from a fleet vehicle to another vehicle may be undertaken by the employee as a means of receiving free fuel for private travel

Systems and methods which track fuel purchases by vehicles and calculate fuel efficiency are known in the art of fleet management. However, typically these systems and methods do not detect changes in fuel efficiency and report these changes to a fleet manager.

U.S. Pat. No. 4,490,798 to Franks et al. teaches a fuel dispensing and maintenance system. Franks does not teach automated acquisition of vehicle operation parameter data, but requires manual entry of such data. Further, Franks teaches storage of this manuaslly entered data for use in a subsequent fueling event. Thus, according to the teachings of Franks, a single error in entry of vehicle operation parameter data will cause an error in calculated fuel efficiency for both the current fueling event and the next fueling event.

German patent DE 199337327 teaches collecting operating data automatically from a vehicle and calculating secondary data from the operating data. This patent does not teach reporting of unauthorized removal of fuel from, or introduction of fuel into, a vehicle.

European Patent Application EP 0955612 by Perl teaches an electronic automatic system and method for recording fuel expenses so as to be usable as a fiscal document. Perl does not teach automated acquisition of vehicle operation parameter data. Instead, Perl teaches registration of this data by means of a TCC.

There is thus a widely recognized need for, and it would be highly advantageous to have, a system and method for detecting and reporting irregularities in fuel efficiency data of a vehicle devoid of the above limitations.

### SUMMARY OF THE INVENTION

According to one aspect of the present invention there is provided a system for detecting and reporting irregularities in fuel efficiency data of a vehicle. The system includes a data base of fueling transactions for at least one vehicle which contains fueling event data, vehicle identification data and data pertaining to at least one vehicle operation parameter. The system further includes a data processing mechanism designed and configured for: (i) calculating a vehicle specific fuel efficiency statistic from the data pertaining to at least one vehicle operation parameter and the fueling event data and the vehicle identification data; (ii) comparing the vehicle specific fuel efficiency statistic to at least one previously calculated vehicle specific fuel efficiency statistic for the same vehicle employing a predetermined rule to determine if the vehicle specific fuel efficiency statistic is unreliable; and (iii) preparing a report which indicates the unreliable vehicle specific fuel efficiency statistic.

According to another aspect of the present invention there is provided a method for detecting and reporting irregularities in fuel efficiency data of a vehicle. The method includes maintaining a data base of fueling transactions for at least one vehicle which contains fueling event data, vehicle identification data and data pertaining to at least one vehicle operation parameter. The method further includes supplying data from the data base to a data processing mechanism. The data processing mechanism is designed and configured for: (i) calculating a vehicle specific fuel efficiency statistic from the data pertaining to at least one vehicle operation parameter, the vehicle identification data and the fueling event data; and (ii) comparing the vehicle specific fuel efficiency statistic to at least one previously calculated vehicle specific fuel efficiency statistic for the same vehicle employing a predetermined rule to determine if the vehicle specific fuel efficiency statistic is unreliable; and (iii) preparing a report which indicates the unreliable vehicle specific fuel efficiency statistic. The net result of the mehod is that reports indicating unreliable vehicle specific fuel efficiency statistics are prepared automatically.

According to further features in preferred embodiments of the invention described below, the fueling event data includes at least one item selected from the group consisting of a fuel volume, vehicle identification data, temporal data pertaining to a fueling event, a fuel type, and a location.

According to still further features in the described preferred embodiments the fueling event data is selected from the group consisting of a most recent fueling event and data pertaining to a previous fueling event.

According to still further features in the described preferred embodiments the at least one vehicle operation parameter is selected from the group consisting of a distance traveled, a number of engine revolutions, and an amount of time during which an engine has been operated.

According to still further features in the described preferred embodiments the system further includes a vehicle mounted data storage device designed and configured to: (i) receive and store vehicle identification data; (ii) automatically acquire and store data pertaining to the at least one vehicle operation parameter; and (iii) transfer the stored vehicle identification data and stored data pertaining to the at least one vehicle operation parameter as a set to the database.

According to still further features in the described preferred embodiments the transfer occurs concurrently with a fueling event.

According to still further features in the described preferred embodiments the vehicle mounted data storage device is mounted near an aperture of a fuel tank of the vehicle.

According to still further features in the described preferred embodiments the at least one previously calculated vehicle specific fuel efficiency statistic is selected from the group consisting of a fuel efficiency statistic supplied by a manufacturer of the vehicle and at least one vehicle specific fuel efficiency statistic previously calculated by the system.

According to still further features in the described preferred embodiments the predetermined rule is selected from the group consisting of an arithmetic rule and a statistical rule.

According to still further features in the described preferred embodiments unreliable indicates that an event selected from the group consisting of a fueling event not stored in the database and unauthorized removal of fuel from the vehicle has occurred.

According to still further features in the described preferred embodiments the report is selected from the group consisting of a digital file residing in a memory of the data processing mechanism, a printed document, and at least one item displayed upon a display device.

According to still further features in the described preferred embodiments the method further includes employing a vehicle mounted data storage device to: (i) receive and store the vehicle identification data; (ii) automatically acquire and store data pertaining to the at least one vehicle operation parameter; and (iii) transfer the stored vehicle identification data and stored data pertaining to the at least one vehicle operation parameter as a set to the database.

The present invention successfully addresses the shortcomings of the presently known configurations by providing a system and method for detecting and reporting irregularities in fuel efficiency data of a vehicle which does not require manual entry of data pertaining to a vehicle operation parameter.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic representation of essential components of a system according to the present invention;

FIG. 2 is a flow diagram of steps in a method according to the present invention;

FIG. 3 is a sample of a report generated by a system/method according to the present invention.

### DESCRIPTION OF THE PREFERRED EMBODIMENTS

The present invention is of a system and method for detecting and reporting irregularities in fuel efficiency data of a vehicle which can be employed to, for example, simplify fleet management. Specifically, the present invention can be used to assure that unauthorized removal of fuel from, or introduction of fuel into, a vehicle will be discovered, for example by fleet management personnel.

The principles and operation of a system and method for detecting and reporting irregularities in fuel efficiency data of a vehicle according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

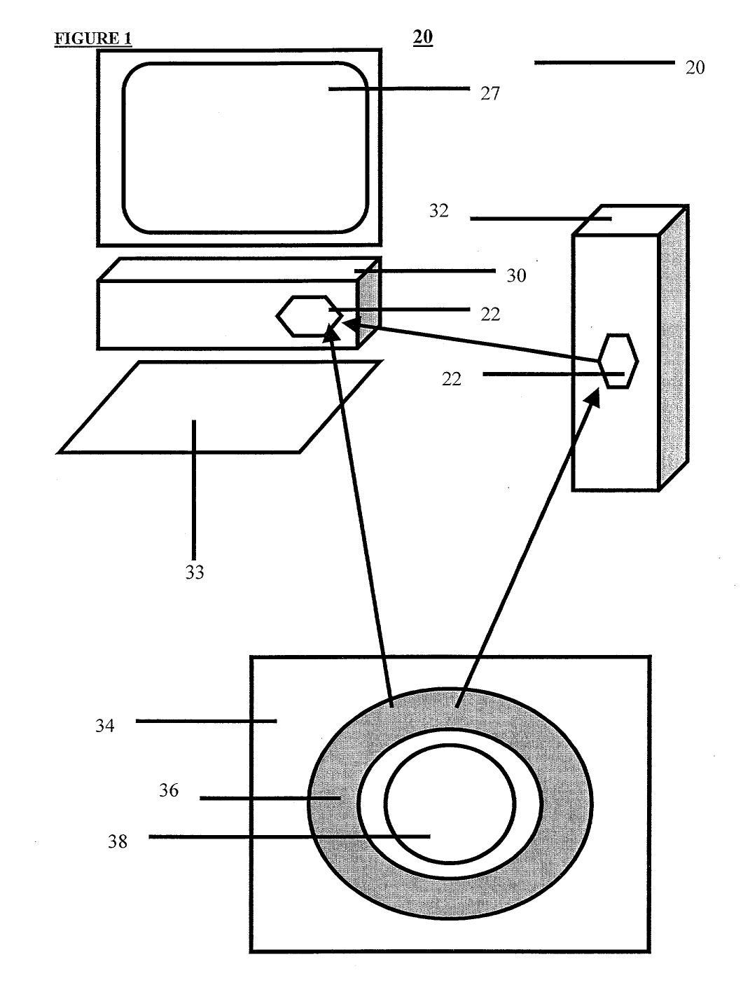

Referring now to the drawings, FIG. 1 illustrates a system 20 for detecting and reporting irregularities in fuel efficiency data of a vehicle. The system includes a data base 22 of fueling transactions for at least one vehicle. Database 22 contains fueling event data, vehicle identification data and data pertaining to at least one vehicle operation parameter. Vehicle identification data may include, for example, items such as license plate number, engine number, vehicle number within a fleet, lease contract number or any other convenient identifier. The fueling event data may include, for example, a fuel volume, vehicle identification data, temporal data pertaining to a fueling event, a fuel type, and a location. Preferably, database 22 contains data pertaining to a plurality of vehicles belonging to a commercial fleet. For purposes of this specification and the accompanying claims, the term “fleet” refers to a collection of vehicles managed as a group by a central managing authority. As such, vehicles in a fleet may be similar to one another, or different. For example a single fleet may contain heavy construction equipment such as cement mixers and bulldozers, as well as passenger vehicles.

The fueling event data in database 22 necessarily includes data pertaining to the most recent (i.e. current) fueling event and preferably contains data pertaining to a previous fueling event, more preferably to as series of previous fueling events.

For purposes of this specification and accompanying claims the phrase “vehicle operation parameter” is selected from the group consisting of a distance traveled (e.g. kilometers or miles), a number of engine revolutions, and an amount of time during which an engine has been operated (e.g. engine hours). For a fleet including only passenger vehicles, distance traveled will be most commonly employed. In some cases it may be more advantageous to use other vehicle operation parameters, for example in managing a fleet of taxis which are expected to spend considerable amounts of time idling in heavy traffic.

System 20 further includes a data processing mechanism 30 or 32 designed and configured for calculating a vehicle specific fuel efficiency statistic from data in database 22. FIG. 1 illustrates that database 22 may reside in a conventional desktop computer 30. Database 22 may reside in an internal memory of computer 30 or on removable media, for example a CD ROM disk. Alternately or additionally, at least a portion of database 22 may reside on server 32. For purposes of this specification and the accompanying claims, the term “server” refers to any computing machine cabable of exchanging data with at least one other computing or data processing machine. A single server may comprise an individual computing machine or a plurality of such machines acting in concert to performm a function requested by at least one other computing machine. Thus, FIG. 1 shows that according to some preferred embodiments of the claimed system, computer 30 is a user client of server 32. For purposes of this specification and the accompanying claims, the phrase “user client” generally refers to a computer and includes, but is not limited to, personal computers (PC) having an operating system such as DOS, Windows™, OS/2™ or Linux; Macintosh™, Palm OS™, EPOC™ computers; computers having JAVA-OS as the operating system; and graphical workstations such as the computers of Sun Microsystems™ and Silicon Graphics™, and other computers having some version of the UNIX operating system such as AIX™ or SOLARIS™ of Sun Microsystems™; or any other known and available operating system; personal digital assistants (PDA), cellular telephones having computer capabilities, a telephone having computer capabilities and Web TVs, each of which is known to include an inherent or connectable display device.

For purposes of this specification and the accompanying claims, the term “Windows™” includes but is not limited to Windows 95™, Windows 2000™ Windows 3.x™ in which “x” is an integer such as “1”, Windows NT™, Windows 98™, Windows CE™, Windows XP™ and any upgraded versions of these operating systems by Microsoft Corp (USA) and/or window managers for the graphical X Windows system for UNIX based operating systems and/or its variants such as Linux.

Arrows in FIG. 1 indicate channels of communication between server 32 and user client 30, as well as between vehicle 34 and database 22. For purposes of this specification and the accompanying claims, the phrase “channel of communication” refers to a telephone connection, a cellular telephone connection, an Internet connection, an infrared frequency transmission connection, a local area network connection, a radio frequency connection, a fiber-optic connection or a connection by a wire. Inherent in the idea of a communication channel is an open status during which data transmission may occur. In some cases, communication channels may also have a closed status during which no data transmission may occur.

The data processing mechanism 30 or 32, is further designed and configured for comparing the vehicle specific fuel efficiency statistic to at least one previously calculated vehicle specific fuel efficiency statistic for the same vehicle employing a predetermined rule to determine if the vehicle specific fuel efficiency statistic is unreliable. The previously calculated vehicle specific fuel efficiency statistic may be, for example, a fuel efficiency statistic supplied by a manufacturer of the vehicle. This type of statistic is employed by the system for a vehicle which has recently entered the fleet. Alternately, and preferably, the vehicle specific fuel efficiency statistic employed for comparison is one previously calculated by the system. Most preferably, comparison is to a series of previously calculated statistics for the same vehicle. The predetermined rule may be, for example, an arithmetic rule (e.g. greater than 10% different from the average of the last 3 caclculated statistics for the same vehicle). Alternately, the predetermined rule may be a statistical rule (e.g. outside of a 95% confidence interval for the same vehicle). According to alternate preferred embodiments of the invention, a vehicle specific fuel efficiency statistic may be compared to statistics from other similar vehicles in the fleet in order to determine reliability.

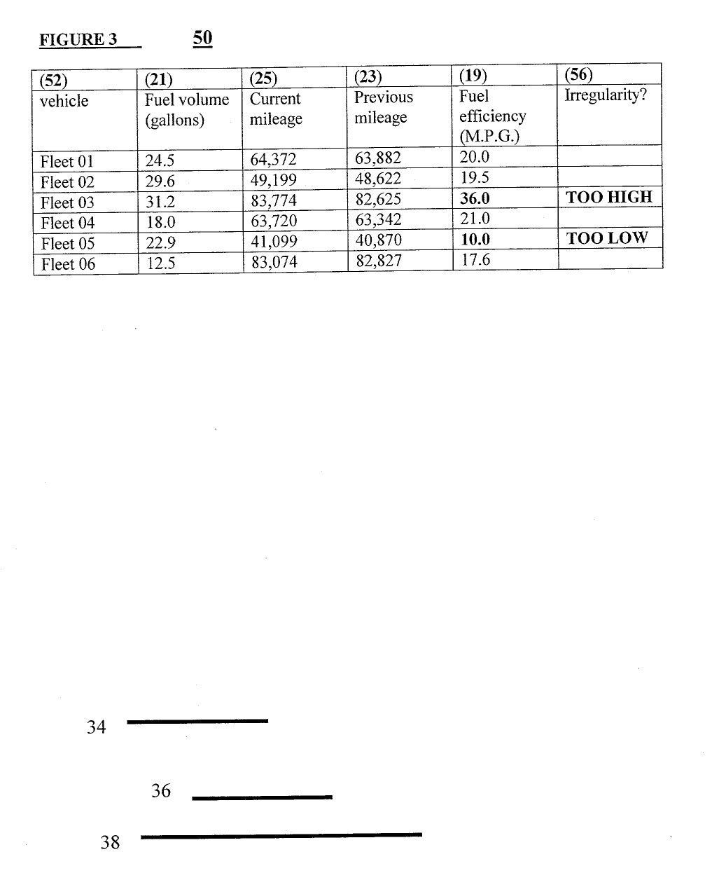

The data processing mechanism 30 or 32, is further designed and configured to prepare a report 50 (FIG. 3) which indicates the unreliable 56 vehicle specific fuel efficiency statistic.

Preferably, system 20 further includes a vehicle 34 mounted data storage device 36 designed and configured to receive and store vehicle identification data and to automatically acquire and store data pertaining to the at least one vehicle operation parameter. Preferably, vehicle mounted data storage device 36 further transfers stored vehicle identification data and stored data pertaining to the at least one vehicle operation parameter as a set to database 22. Preferably, this transfer occurs concurrently with a fueling event. Preferably vehicle 34 mounted data storage device 36 is mounted near an aperture of a fuel tank 38 of vehicle 34. Data storage device 36 is capable of communication with another device on vehicle 34 which supplies data pertaining to a vehicle operation parameter.

As used herein, the term “unreliable” may indicate either occurrence of a fueling event not stored in database 22 (if the calculated statistic is too high) or unauthorized removal of fuel from the vehicle (if the calculated statistic is too low).

Report 50 may be, for example, a digital file residing in a memory of data processing mechanism 30 or 32. A digital file residing on server 32 may be accessible via the Internet using a Web browser so that report 50 mayy be delivered to fleet management personnel in the form of a Web page. For purposes of this specification and the accompanying claims, the phrase “Web browser” or “browser”, refers to any software program which can display text, graphics, or both, as well as display video, and/or play sounds, from Web pages on World Wide Web sites and or local files.

For purposes of this specification and the accompanying claims, the phrase “Web page” refers to any document written in a “mark-up language”, or “script language”, or any programming language or tool. For purposes of this specification and the accompanying claims, the phrase “mark up language” includes, but is not limited to, HTML (hypertext mark-up language) or VRML (virtual reality modeling language), dynamic HTML, XML (extended mark-up language) or related computer languages thereof, as well as to any collection of such documents reachable through one specific Internet address or at one specific World Wide Web site, or any document obtainable through a particular URL (Uniform Resource Locator). Script languages include, but are not limited to, CGI, PERL, VBScript, JavaScript, ASP.

Thus, according to some preferred embodiments of the invention, server 32 is a “Web server” designed and configured for providing one or more Web pages to a Web browser upon request.

According to these preferred embodiments of the invention, computer 30 is capable of displaying a web page. The phrase “display a Web page” includes all actions necessary to render at least a portion of the information on the Web page available to a user of computer 30. As such, the phrase includes, but is not limited to, the static visual display of static textual or graphical information, the audible production of audio information, the animated visual display of animation and the visual display of video stream data.

According to alternate preferred embodiments of the invention, report 50 is a printed document or an item displayed upon display device 27 of computer 30.

Thus, according to various preferred embodiments of the invention, managerial staff of a fleet of vehicles may quiclkly and efficiently discover abuse of fleet resources by inputting simple commands to computer 30 from input device 33 (e.g. keyboard).

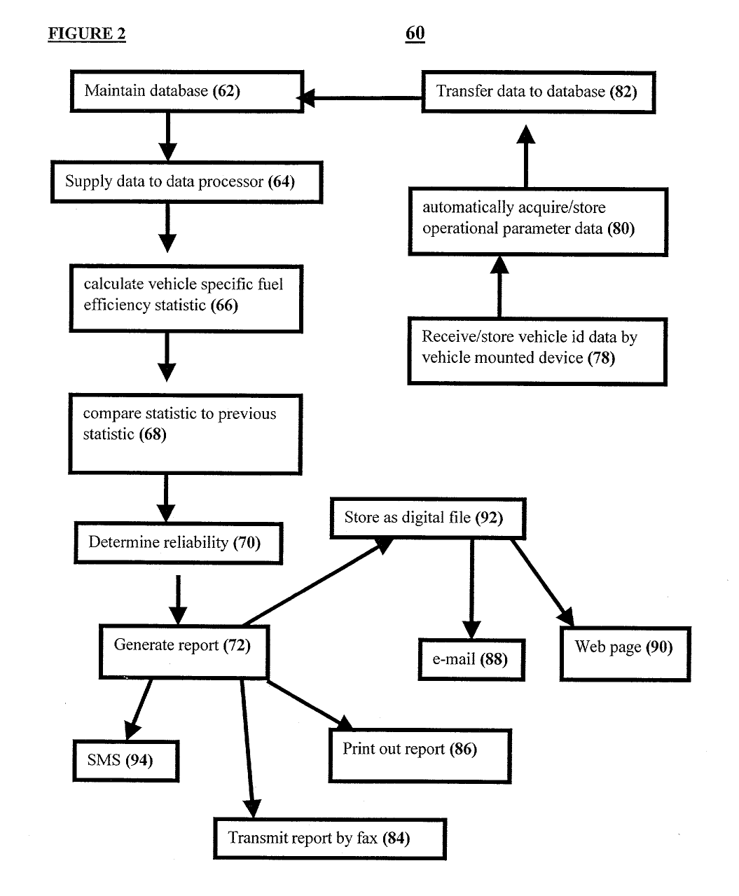

The present invention is further embodied by a method 60 for detecting and reporting irregularities in fuel efficiency data of a vehicle (FIG. 2). Method 60 includes maintaining 62 a data base 22 of fueling transactions for at least one vehicle. Database 22 is as described hereinabove. Method 60 further includes supplying data 64 from data base 22 to a data processing mechanism (e.g. 30 or 32). Data processing mechanism 30 or 32 is designed and configured for calculating a vehicle specific fuel efficiency statistic 66, comparing the vehicle specific fuel efficiency statistic to at least one previously calculated vehicle specific fuel efficiency statistic 68 employing a predetermined rule to determine if the vehicle specific fuel efficiency statistic is unreliable 70 and preparing a report 72 which indicates the unreliable vehicle specific fuel efficiency statistic. The net result of method 50 is that reports 50 indicating unreliable vehicle specific fuel efficiency statistics are prepared automatically.

Preferably, method 60 further includes employing a vehicle mounted data storage device 36 to receive and store vehicle identification data 78, automatically acquire and store 80 data pertaining to the at least one vehicle operation parameter and transfer 82 the stored vehicle identification data and stored data pertaining to the at least one vehicle operation parameter as a set to database 22.

According to various preferred embodiments of method 60, report 50 may be printed 86, transmitted by fax 84, sent as an SMS message 94 to a cellular telephone or personal digital assistant, or stored 92 as a digital file. Digital files may be subject to additional steps, such as formatting 90 as a Web page using a mark up language or electronic transfer to to a user client, for example via e-mail 88.

FIG. 3 shows a non-limiting illustrative example of report 50 according to the present invention. Vehicle identification data 52 is presented in the left hand column. In this example, numbers of vehicles with in the fleet are employed. Fueling event data, in the form of fuel volume 21 is presented for each vehicle. This data refers to a current fueling event and has been used in calculating fuel efficiency 19 which is a n efficiency statistic. Current mileage 25 and previous mileage 23 are examples of data pertaining to a vehicle opewration parameter. According to this illustrative example, all six vehicles in the fleet are passenger cars with a fuel efficiency rating from the manufacturer of 20 M.P.G. Actual efficiencies 19 are close to this estimate for all cars in the fleet except for Fleet 03 and Fleet 05. According to the present invention, attention is called to these items in the report, for example by indicating fuel efficiency statistics for these vehicles in boldface type. Further, an additional column 56, may be added to report 50 to highlight the irregularities. In this example Fleet 05 has apparently had gasoline removed from its fuel tank. Fleet 03 has apparently consumed fuel added during a fueling event which is not in databse 22. While the fuel efficiency of Fleet 06, is unusual, it has met criteria established by a predetermined rule and has not been deemed irregular.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for detecting and reporting irregularities in fuel efficiency data of a vehicle, the system comprising;
(a) a data base of fueling transactions for at least one vehicle, said data base containing fueling event data, vehicle identification data and data pertaining to at least one vehicle operation parameter;
(b) a data processing mechanismdesigned and configured for:
(i) calculating a vehicle specific fuel efficiency statistic from said data pertaining to at least one vehicle operation parameter and said fueling event data and said vehicle identification data;
(ii) comparing said vehicle specific fuel efficiency statistic to at least one previously calculated vehicle specific fuel efficiency statistic for the same vehicle employing a predetermined rule to determine if said vehicle specific fuel efficiency statistic is unreliable; and
(iii) preparing a report which indicates said unreliable vehicle specific fuel efficiency statistic.

2. The system of claim 1, wherein said fueling event data includes at least one item selected from the group consisting of a fuel volume, vehicle identification data, temporal data pertaining to a fueling event, a fuel type, and a location.

3. The system of claim 1, wherein said fueling event data is selected from the group consisting of a most recent fueling event and data pertaining to a previous fueling event.

4. The system of claim 1, wherein said at least one vehicle operation parameter is selected from the group consisting of a distance traveled, a number of engine revolutions, and an amount of time during which an engine has been operated.

5. The system of claim 1, further including a vehicle mounted data storage device designed and configured to:
(i) receive and store vehicle identification data;
(ii) automatically acquire and store data pertaining to said at least one vehicle operation parameter; and
(iii) transfer said stored vehicle identification data and stored data pertaining to said at least one vehicle operation parameter as a set to said database.

6. The system of claim 5, wherein said transfer occurs concurrently with a fueling event.

7. The system of claim 5, wherein said vehicle mounted data storage device is mounted near an aperture of a fuel tank of the vehicle.

8. The system of claim 1, wherein said at least one previously calculated vehicle specific fuel efficiency statistic is selected from the group consisting of a fuel efficiency statistic supplied by a manufacturer of the vehicle and at least one vehicle specific fuel efficiency statistic previously calculated by the system.

9. The system of claim 1, wherein said predetermined rule is selected from the group consisting of an arithmetic rule and a statistical rule.

10. The system of claim 1, wherein unreliable indicates that an event selected from the group consisting of a fueling event not stored in said database and unauthorized removal of fuel from the vehicle has occurred.

11. The system of claim 1, wherein said report is selected from the group consisting of a digital file residing in a memory of said data processing mechanism, a printed document, and at least one item displayed upon a display device.

12. A method for detecting and reporting irregularities in fuel efficiency data of a vehicle, the method comprising;
(a) maintaining a data base of fueling transactions for at least one vehicle, said data base containing fueling event data, vehicle identification data and data pertaining to at least one vehicle operation parameter;
(b) supplying data from said data base to a data processing mechanism designed and configured for:
(i) calculating a vehicle specific fuel efficiency statistic from said data pertaining to at least one vehicle operation parameter, said vehicle identification data and said fueling event data; and
(ii) comparing said vehicle specific fuel efficiency statistic to at least one previously calculated vehicle specific fuel efficiency statistic for the same vehicle employing a predetermined rule to determine if said vehicle specific fuel efficiency statistic is unreliable.
(iii) preparing a report which indicates said unreliable vehicle specific fuel efficiency statistic;
such that reports indicating said unreliable vehicle specific fuel efficiency statistics are prepared automatically.

13. The method of claim 12, wherein said fueling event data includes at least one item selected from the group consisting of a fuel volume, vehicle identification data, temporal data pertaining to a fueling event, a fuel type, and a location.

14. The method of claim 12, further including:
(c) employing a vehicle mounted data storage device to:
(i) receive and store said vehicle identification data;
(ii) automatically acquire and store data pertaining to said at least one vehicle operation parameter; and
(iii) transfer said stored vehicle identification data and stored data pertaining to said at least one vehicle operation parameter as a set to said database.

15. The method of claim 14, wherein said transfer occurs concurrently with a fueling event.

16. The method of claim 12, wherein said at least one vehicle operation parameter is selected from the group consisting of a distance traveled, a number of engine revolutions, and an amount of time during which an engine has been operated.

17. The method of claim 14, further comprising mounting said vehicle mounted data storage device near an aperture of a fuel tank of the vehicle.

18. The method of claim 12, wherein said at least one previously calculated vehicle specific fuel efficiency statistic is selected from the group consisting of a fuel efficiency statistic supplied by a manufacturer of the vehicle and at least one vehicle specific fuel efficiency statistic previously calculated by the method.

19. The method of claim 12, wherein said predetermined rule is selected from the group consisting of an arithmetic rule and a statistical rule.

20. The method of claim 12, wherein unreliable indicates that an event selected from the group consisting of a fueling event not stored in said database and unauthorized removal of fuel from the vehicle has occurred.

21. The method of claim 12, wherein said report is selected from the group consisting of a digital file residing in a memory of said data processing mechanism, a printed document, and at least one item displayed upon a display device.
